(19) United States
(12) Patent Application Publication
(10) Pub. No.: US 2025/0211930 A1
(43) Pub. Date: Jun. 26, 2025

(54) EMERGENCY BROADCAST SYSTEM AND SPEAKER UNIT

(71) Applicant: TOA Corporation, Hyogo (JP)

(72) Inventors: Kazuma ASADA, Hyogo (JP); Makoto NISHIO, Hyogo (JP)

(73) Assignee: TOA Corporation, Hyogo (JP)

(21) Appl. No.: 18/851,075

(22) PCT Filed: Mar. 31, 2022
(86) PCT No.: PCT/JP2022/016769

§ 371 Date: Sep. 26, 2024

(51) Int. Cl. H04R 27/00; G08B 3/10; G08B 5/36; G08B 7/06; H05B 47/105; H05B 47/17

(52) U.S. Cl. CPC H04R 27/00; G08B 3/10; G08B 5/36; G08B 7/06; H05B 47/105; H05B 47/172; H04R 2430/01

(57) ABSTRACT

[Problem] To make it possible to visually recognize emergency broadcast audio that is output from a speaker to residents in a coverage area of an emergency broadcast system.

[Solution] The present invention comprises an emergency broadcast device 2 that can switch between any normal broadcast and an emergency broadcast that includes an emergency alert, both broadcasts being constituted by audio signals, and one or more speaker units 3 to which the audio signal is transmitted from the emergency broadcast device 2 through a speaker line 4, wherein: the speaker unit 3 includes a speaker 32 to which the audio signal of the normal broadcast and the audio signal of the emergency broadcast are input, a power receiving circuit 33 that extracts a direct-current power supply from the audio signal of the emergency broadcast, and a lighting controller 34 that performs lighting control on a light emitting element 35 by using the direct-current power supply; and the light emitting element 35 is not lit during the normal broadcast, but is lit during then emergency broadcast.

### TECHNICAL FIELD

The present invention relates to an emergency public address system and a speaker unit, and more particularly, to improvements of an emergency public address system for delivering voice public address during disasters, as well as improvements of the speaker unit used in the emergency public address system.

### BACKGROUND OF THE INVENTION

Emergency public address systems that provide evacuation guidance through voice public address during disasters such as fires and earthquakes have been conventionally known. An emergency public address system is configured by connecting one or more speakers to an emergency public address device that generates voice signals. It conducts a regular public address during normal times when no disaster is detected, while performing an emergency public address when a disaster is detected.

A regular public address includes a voice public address such as BGM and business communication messages, while an emergency publica address includes a voice public address such as emergency alarms and evacuation guidance messages. The emergency public address device switches from the regular public address to the emergency public address based on a transfer signal from, for example, an automatic fire alarm. Additionally, two or more speakers are installed at predetermined intervals within the coverage area of the emergency public address system, allowing the emergency public address to be heard from any position within the coverage area.

A voice public address is effective as a method of guiding the evacuation of an unspecified number of people within the coverage area, but there may be situations where the occupants cannot respond to the voice public address. For instance, if the occupants are hearing-impaired or wearing earphones, or if the coverage area is in a noisy environment with high-volume sound, it is possible that they may not notice the emergency public address or may be delayed in noticing it. Therefore, in addition to the voice public address, it is considered effective to use visual notifications with light-emitting elements to visually inform the occupants that an emergency public address is being conducted.

In a typical emergency public address system, speakers are connected to the emergency public address device via speaker lines, and the emergency public address device operates using power supplied from an emergency power source, even during a power outage. Meanwhile, the speakers operate solely on the audio signals input through the speaker lines. Therefore, each speaker can perform the emergency public address even during a power outage without the need to secure an individual emergency power source. However, in such an emergency public address system, if light-emitting elements are to be activated in conjunction with the emergency public address, it would be necessary to secure a new external power source, leading to a significant increase in cost, making it difficult to implement.

AV equipment and gaming devices that synchronize acoustic effects from speakers with optical effects from light-emitting elements have been conventionally known (for example, Patent Literature 1). In the invention described in Patent Literature 1, drive power is extracted from the speaker's audio signal to control the lighting of the light-emitting elements. Therefore, as the volume of the audio signal increases, the light emission from the light-emitting elements also increases, and the light emission changes in sync with the changes in volume.

In the invention of Patent Literature 1, it is possible to light the light-emitting elements without securing a new external power source for them. However, the invention of Patent Literature 1 relates to gaming machines and not to emergency public address systems. Additionally, the light emission from the light-emitting elements varies according to the volume, and it does not distinguish between the regular public address and the emergency address, nor does it visually indicate that the emergency public address is being conducted.

### CITATION LIST

### Patent Literatures

[Patent Literature 1] JP 2018-152832 A

### SUMMARY OF THE INVENTION

### Technical Problem

The present invention has been made in view of the above circumstances and aims to make it possible for occupants within the coverage area of an emergency public address system to visually recognize that the emergency public address audio is being output from the speakers. Another object is to provide such an emergency public address system at a low cost. Additionally, it aims to provide a speaker system applicable to such an emergency public address system at a low cost.

### Solution to the Problem

An emergency public address system according to the first embodiment of the present invention includes an emergency public address device that switches between an arbitrary regular public address and an emergency public address, both public addresses including an audio signal, the emergency public address including an emergency alarm, and one or more speaker units interrelated with the emergency public address device via a speaker line. Wherein the speaker unit includes a speaker that receives the audio signal of the regular public address and the audio signal of the emergency public address, a power reception circuit that extracts DC power from the audio signal of the emergency public address, and a lighting controller that controls a lighting of a light-emitting element using the DC power, and the light-emitting element does not light during the regular public address and lights during the emergency public address.

By adopting this configuration, the light-emitting element can be lit without the need for an additional external power source. Furthermore, by ensuring that the light-emitting element does not light during the regular public address but does light during the emergency public address, it becomes possible to visually recognize that the audio for the emergency public address is being output.

An emergency public address system according to the second embodiment of the present invention adds the following features to the configuration described above. The speaker line includes a common line that transmits a reference level, a normal signal line that transmits the audio signal of the regular public address, and an emergency signal line that transmits the reference level during the regular public address and transmits the audio signal during the emergency public address, the speaker receives the audio signal from the normal signal line during the regular public address and receives the audio signal from the emergency signal line during the emergency public address, and the power reception circuit extracts the DC power from the audio signal on the emergency signal line.

By adopting this configuration, while it is not possible to extract DC power during the regular public address, DC power can be extracted during the emergency public address. As a result, the light-emitting element does not light during the regular public address, but it can be lit during the emergency public address. Therefore, in an emergency public address system where the speaker line includes a common line, a normal signal line, and an emergency signal line, it becomes possible to visually recognize that the audio for the emergency public address is being output.

An emergency public address system according to the third embodiment of the present invention adds the following features to the configuration described above. The lighting controller identifies whether the emergency public address device is performing the emergency public address based on a signal level of the emergency signal line, and the light-emitting element lights in sync with the emergency public address based on an identification result.

By adopting this configuration, the light-emitting element can be lit in sync with the emergency public address, making it possible to visually recognize that the emergency public address is being conducted.

An emergency public address system according to the fourth embodiment of the present invention adds the following features to the configuration described above. The lighting controller identifies whether the emergency alarm is being output from the emergency public address device based on a signal level of the emergency signal line, and the light-emitting element lights in sync with the emergency alarm based on an identification result.

By adopting this configuration, the light-emitting element can be lit in sync with the emergency alarm, making it possible to visually recognize that the emergency alarm is sounding.

An emergency public address system according to the fifth embodiment of the emergency public address further includes an alarm identifier that identifies whether the emergency alarm is being output from the emergency public address device based on a frequency component contained in the audio signal on the emergency signal line. Wherein the light-emitting element lights in sync with the emergency alarm based on an identification result.

By adopting this configuration, the light-emitting element can be lit in sync with the emergency alarm, making it possible to visually recognize that the emergency alarm is sounding. This configuration allows for more reliable detection of the emergency alarm, especially compared to detection methods based on variable voltage levels.

An emergency public address system according to the sixth embodiment of the present invention adds the following features to the configuration described above. The emergency public address system further includes a public address type receiver that receives a public address type signal, from the emergency public address device, indicating either the regular public address or the emergency public address. Wherein the speaker line includes a pair of audio signal lines that transmit the audio signal and a pair of type signal lines that transmit the public address type signal, and the power reception circuit generates the DC power from the audio signal on the audio signal lines.

By adopting this configuration, in an emergency public address system where the speaker line includes a pair of audio signal lines and a pair of type signal lines, it becomes possible to visually recognize that the audio for the emergency public address is being output.

An emergency public address system according to the seventh embodiment of the present invention adds the following features to the configuration described above. The lighting controller identifies whether the audio signal is being output from the emergency public address device based on a signal level of the audio signal, and the light-emitting element lights in sync with the audio signal of the emergency public address.

By adopting this configuration, the light-emitting element can be lit in sync with the audio signal of the emergency public address, making it possible to visually recognize that the emergency public address is being conducted.

An emergency public address system according to the eighth embodiment of the lighting controller identifies whether the emergency alarm is being output from the emergency public address device based on a signal level of the audio signal, and the light-emitting element lights in sync with the emergency alarm.

By adopting this configuration, the light-emitting element can be lit in sync with the emergency alarm, making it possible to visually recognize that the emergency alarm is sounding. In particular, by identifying the emergency alarm based on the public address type signal and the signal level of the audio signal, it is possible to detect the emergency alarm with high accuracy and prevent false detections.

An emergency public address system according to the ninth embodiment of the present invention adds the following features to the configuration described above. The emergency public address system further includes an alarm identifier that identifies whether the emergency alarm is being output from the emergency public address device based on a frequency component contained in the audio signal. The light-emitting element lights in sync with the emergency alarm based on the public address type signal and an identification result.

By adopting this configuration, the light-emitting element can be lit in sync with the emergency alarm, making it possible to visually recognize that the emergency alarm is sounding. In particular, by identifying the emergency alarm signal based on the public address type signal and the frequency components of the audio signal, it is possible to detect the emergency alarm with high accuracy and prevent false detections.

A speaker unit according to the tenth embodiment of the present invention is a speaker unit connected via a speaker line to an emergency public address device that switches between an arbitrary regular public address and an emergency public address, both public addresses including an audio signal, the emergency public address including an emergency alarm, and to which the audio signals are transmitted from the emergency public address device. The speaker unit includes a speaker that receives the audio signal of the regular public address and the audio signal of the emergency public address, a power reception circuit that extracts DC power from the audio signal of the emergency public address, and a lighting controller that controls a lighting of a light-emitting element using the DC power. Wherein the light-emitting element does not light during the regular public address and lights during the emergency public address.

By adopting this configuration, the light-emitting element can be lit without the need for an additional external power source. Furthermore, by ensuring that the light-emitting element does not light during the regular public address but does light during the emergency public address, it becomes possible to visually recognize that the audio for the emergency public address is being output.

A speaker unit according to the eleventh embodiment of the present invention adds the following features to the configuration described above. The power reception circuit includes a rectifier circuit that rectifies the audio signal, a capacitance that smooths an output voltage of the rectifier circuit, and a current suppression circuit that suppresses a generation of harmonics of the audio signal in the speaker line.

By adopting this configuration, the brightness of the light-emitting element can be kept constant during operation, while also preventing the distortion of the audio signal and the reduction in the clarity of the public address audio.

### Advantages of the Invention

According to the present invention, it is possible for occupants within the coverage area of an emergency public address system to visually recognize that the emergency public address audio is being output from the speakers, thereby preventing them from failing to notice or being delayed in noticing the emergency public address. Additionally, such an emergency public address system can be provided at a low cost. Furthermore, a speaker system applicable to such an emergency public address system can also be provided at a low cost.

### BRIEF DESCRIPTION OF DRAWINGS

FIG. 1 is a diagram showing the configuration of the emergency public address system 100 according to the first embodiment of the present invention.

FIG. 2 is a diagram showing the detailed configuration of the speaker unit 3 in FIG. 1.

FIG. 3 is a diagram showing the detailed configuration of the power reception circuit 33 and the lighting controller 34 in FIG. 2.

FIG. 4 is a diagram showing the configuration of the emergency public address system 101 according to the first embodiment of the present invention.

FIG. 5 is a diagram showing the configuration of the emergency public address system 102 according to the first embodiment of the present invention.

FIG. 6 is a diagram showing the detailed configuration of the alarm identifier 36 in FIG. 5.

FIG. 7 is a diagram showing the configuration of the emergency public address system 103 according to the second embodiment of the present invention.

FIG. 8 is a diagram showing the detailed configuration of the speaker unit 3 in FIG. 7.

FIG. 9 is a diagram showing the configuration of the emergency public address system 104 according to the second embodiment of the present invention.

FIG. 10 is a diagram showing the configuration of the emergency public address system 105 according to the third embodiment of the present invention.

FIG. 11 is a diagram showing an example of the detailed configuration of the speaker unit 3 in FIG. 10.

FIG. 12 is a diagram showing an example of the configuration of the power reception circuit 33 according to the fourth embodiment of the present invention.

FIG. 13 is a diagram showing another example of the configuration of the power reception circuit 33 according to the fourth embodiment of the present invention.

FIG. 14 is a diagram showing yet another example of the configuration of the power reception circuit 33 according to the fourth embodiment of the present invention.

FIG. 15 is a diagram showing still another example of the configuration of the power reception circuit 33 according to the fourth embodiment of the present invention.

### DETAILED DESCRIPTION OF THE INVENTION

### First Embodiment

### (1) Emergency Public Address System

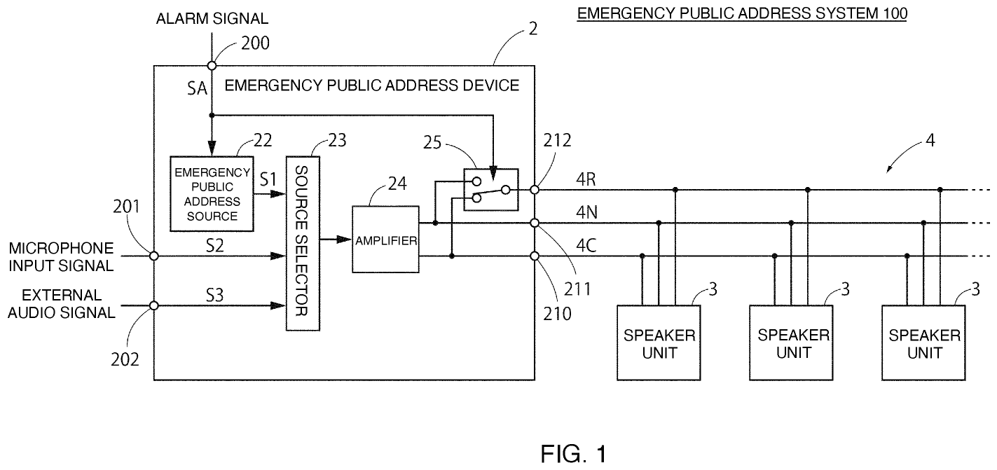

FIG. 1 is a diagram showing an example of the configuration of an emergency public address system according to the first embodiment of the present invention, illustrating the general configuration of the emergency public address system 100. The emergency public address system 100 is a facility-wide public address system installed in indoor spaces of large-scale facilities such as buildings, theaters, and airports, and it includes an emergency public address device 2 that generates an audio signal, one or more speaker units 3 that output the audio, and a speaker line 4 that transmits the audio signal from the emergency public address device 2 to the speaker units 3. The emergency public address device 2 is installed in the disaster management room of the facility, and the two or more speaker units 3 are distributed throughout the facility.

The emergency public address device 2 can switch between the regular public address and the emergency public address, and the speaker units 3 control the lighting of light-emitting elements in sync with the emergency public address. This allows the emergency public address to be visually recognized, thereby aiding in evacuation guidance through audio. For example, even hearing-impaired individuals or those wearing earphones can recognize that an emergency public address is being conducted. Additionally, it ensures that the emergency public address can be recognized even in noisy environments with high volume levels.

The speaker line 4 is a three-wire signal transmission means that includes one or more speaker units 3 connected in parallel. It includes a common line 4C for the reference level, a normal signal line 4N for regular and the emergency public address, and an emergency signal line 4R specifically for the emergency public address. During the regular public address, the audio signal is transmitted using the normal signal line 4N, while the emergency signal line 4R is maintained at the reference level. On the other hand, during the emergency public address, the audio signal is transmitted using both the emergency signal line 4R and the normal signal line 4N.

### (2) Emergency Public Address Device 2

The emergency public address device 2 generates an audio signal for the regular public address or the emergency public address and outputs it to the speaker line 4. The switching between the regular public address and the emergency public address is performed based on an alarm signal SA input from an external source.

A regular public address is an audio public address conducted when no disaster is occurring, generally referred to as business public address, and their content can be specified at the discretion of the administrator. For example, they may include prerecorded BGM, messages, or messages input via a microphone. An emergency public address is an audio public address conducted during a disaster and include at least emergency alarms. They may also include prerecorded messages or messages input via a microphone.

The emergency public address device 2 includes an emergency public address source 22, a source selector 23, an amplifier 24, an emergency public address relay 25, input terminals 200 to 202, and output terminals 210 to 212.

The input terminals 200 to 202 receive the alarm signal SA, the microphone input signal S2, and the external audio source signal S3, respectively. The alarm signal SA is an external signal indicating the occurrence of a disaster, such as a fire or earthquake, and is, for example, a transfer signal output by an automatic fire alarm (not shown) when a fire is detected. The microphone input signal S2 is an audio signal output by a microphone (not shown). The external audio source signal S3 is an audio signal generated by an external audio source (not shown) and includes BGM (Background Music) or messages that constitute the regular public address.

The speaker line 4 is connected to the output terminals 210 to 212, and the audio signal generated by the emergency public address device 2 is transmitted to one or more speaker units 3 via the speaker line 4.

The emergency public address source 22 is a sound source that generates the audio signal S1 for the emergency alarm and evacuation guidance message that constitute the emergency public address, based on the alarm signal SA. The emergency alarm and evacuation guidance message are, for example, pre-stored as recorded audio data or data for speech synthesis, and are played back as the audio signal S1 when a disaster occurs. The emergency alarm is an audio signal with a predetermined frequency and variation pattern.

The source selector 23 selects one of the audio signals S1 to S3 based on the alarm signal SA and the administrator's instructions and outputs it as the public address audio signal. For example, during normal times, either the microphone input signal S2 or the external audio source signal S3 is selected as the audio signal for the regular public address, while during emergencies, either the audio signal S1 from the emergency public address source 22 or the microphone input signal S2 is selected as the audio signal for the emergency public address.

The amplifier 24 is an amplifier that amplifies the audio signal. The amplified signal from the amplifier 24 is output to the normal signal line 4N via the output terminal 211.

The emergency public address relay 25 is a switching means that switches between the regular public address and the emergency public address based on the alarm signal SA, selectively connecting either the common line 4C or the normal signal line 4N to the emergency signal line 4R. In other words, during the regular public address, the emergency signal line 4R is shorted to the common line 4C, and the audio signal is output only to the normal signal line 4N. During the emergency public address, the emergency signal line 4R is shorted to the normal signal line 4N, and the audio signal is output to both the normal signal line 4N and the emergency signal line 4R.

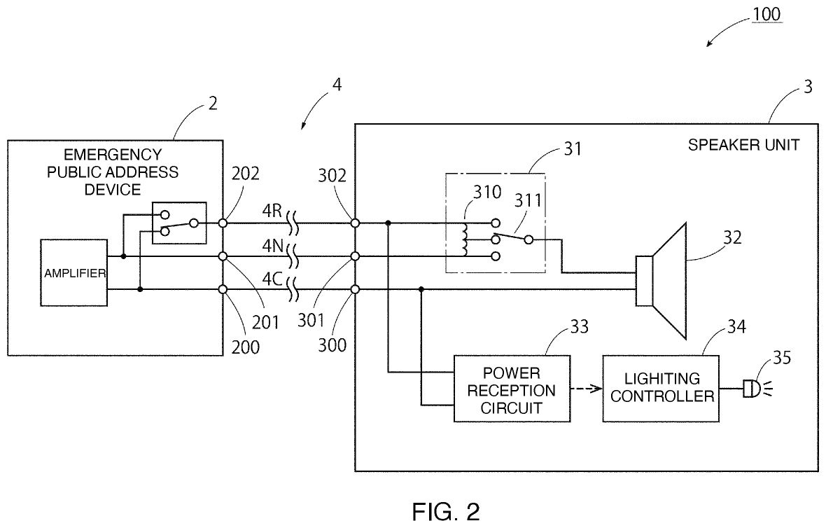

FIG. 2 is a diagram showing an example of the detailed configuration of the speaker unit 3 in FIG. 1. The speaker unit is a device that outputs audio based on the audio signal from the speaker line 4 and lights up a light-emitting element in sync with the emergency public address, making it visually identifiable that an emergency public address is being conducted. Whether it is an emergency public address or not is identified based on the signal level of the emergency signal line 4R. The speaker unit 3 includes input terminals 300 to 302, an attenuator 31, a speaker 32, a power reception circuit 33, a lighting controller 34, and a light-emitting element 35.

The input terminals 300 to 302 are connected to the common line 4C, the normal signal line 4N, and the emergency signal line 4R of the speaker line 4, respectively, and receive the audio signal from the emergency public address device 2.

The attenuator 31 is a volume control means that attenuates the audio signal to adjust the volume. It is configured to allow volume adjustment for the regular public address but not for the emergency public address.

The attenuator 31 is a transformer-type attenuator including an autotransformer 310 and a volume control switch 311. The autotransformer 310 is a single-winding transformer that shares one coil as both the primary and secondary coils. The input terminal pair, provided at both ends of the coil, is connected to the normal signal line 4N and the emergency signal line 4R, and one or more output taps on the coil are used as an output terminal. The volume control switch 311 allows the user to select one of the output taps, supplying the audio signal from the selected output tap to the speaker 32. During the regular public address, the primary terminals of the autotransformer 310 receive the audio signal for the regular public address and the reference level. This allows for volume adjustment by operating the volume control switch 311 to select an output tap. On the other hand, during the emergency public address, the primary terminals of the autotransformer 310 both receive the audio signal for the emergency public address. Therefore, regardless of the output tap selected by the volume control switch 311, the audio signal for the emergency public address is output to the speaker 32 without attenuation by the attenuator 31.

The speaker 32 is a device that converts the audio signal output from the attenuator 31 into sound waves and emits them into the space.

The power reception circuit 33 is a circuit that extracts power from the audio signal. The power reception circuit 33 is connected to the emergency signal line 4R, rectifies the audio signal for the emergency public address to generate a DC voltage, and supplies it to the lighting controller 34. During the regular public address, the emergency signal line 4R maintains the reference level, while during the emergency public address, an audio signal is transmitted. Therefore, the power reception circuit 33 can extract power only during the emergency public address.

The lighting controller 34 is a constant current circuit that supplies a constant current to the light-emitting element 35 based on the DC power supplied from the power reception circuit 33. The light-emitting element 35 is a light-emitting means that lights up by the current supplied from the lighting controller 34, and an LED can be used, for example.

The output voltage of the power reception circuit 33 varies according to the signal level of the audio signal, that is, the volume of the audio signal. The lighting controller 34 supplies power to the light-emitting element 35 only when the input voltage from the power reception circuit 33 exceeds a predetermined threshold voltage Vth. In other words, if the input voltage is below the threshold voltage Vth, no current is supplied to the light-emitting element 35, but if the input voltage exceeds the threshold voltage Vth, a predetermined current is supplied.

Therefore, by setting the threshold voltage Vth to an appropriate value, the light-emitting element 35 can be lit in sync with the audio signal for the emergency public address. In other words, the lighting controller 34 identifies whether the audio signal for the emergency public address is being input based on the volume of the audio signal on the emergency signal line 4R, and lights the light-emitting element 35 based on this identification.

For example, by setting the threshold voltage Vth to a relatively small value, the light-emitting element 35 can be lit in sync with all the audio signals that constitute the emergency public address, including the emergency alarm and evacuation guidance messages.

By setting the threshold voltage Vth to a relatively large value, the light-emitting element 35 can be lit in sync only with the emergency alarm. Typically, an emergency public address includes an emergency alarm, which is louder than other content, such as evacuation guidance messages. Therefore, by setting the threshold voltage Vth to an appropriate value, the light-emitting element 35 can be lit only during the output of the emergency alarm.

When the lighting controller 34 lights the light-emitting element 35, it supplies a predetermined constant current to the light-emitting element 35. This ensures that the light-emitting element 35 is lit with a consistent brightness, clearly indicating that an emergency public address is being conducted.

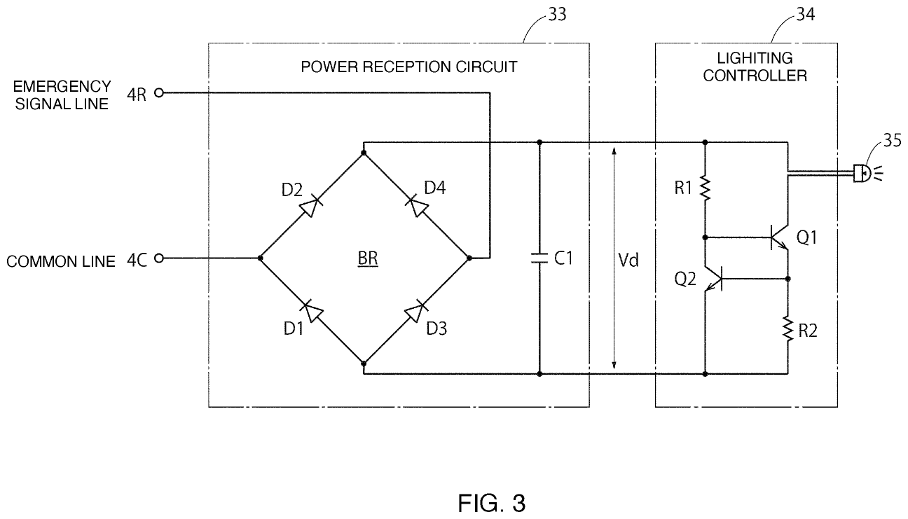

FIG. 3 is a diagram showing an example of the detailed configuration of the power reception circuit 33 and the lighting controller 34 in FIG. 2. The power reception circuit 33 includes a bridge circuit BR having diodes D1 to D4 and a capacitor C1 connected in parallel to the output terminal of the bridge circuit BR.

The bridge circuit BR is a rectifier circuit that performs full-wave rectification of the audio signal. When the audio signal from the emergency signal line 4R is input to the power reception circuit 33, it is rectified by the bridge circuit BR and smoothed by the capacitor C1 to generate a DC voltage Vd. The generated DC voltage Vd is then input to the lighting controller 34.

The lighting controller 34 is a constant current circuit including NPN transistors Q1, Q2, and resistors R1, R2. Transistor Q1 forms an emitter-follower circuit, with its base, emitter, and collector terminals connected to resistor R1, resistor R2, and the light-emitting element 35, respectively. The collector current supplied to the light-emitting element 35 is determined by the base current flowing through resistor R1 and the current gain of transistor Q1.

Transistor Q2 forms a common-emitter circuit, with its collector and base terminals connected to the base and emitter terminals of transistor Q1, respectively. Transistor Q2 turns on due to the voltage drop across resistor R2, thereby regulating the base current of transistor Q1. As a result, a predetermined constant current can be supplied to the light-emitting element 35. Additionally, the power supply voltage Vd required to supply a constant current to the light-emitting element 35, i.e., the voltage threshold Vth, is determined by resistors R1 and R2.

In the emergency public address system 100 according to this embodiment, power is extracted from the audio signal to light the light-emitting element 35, allowing the light-emitting element 35 to be lit without the need for an additional external power source. Furthermore, by extracting power from the audio signal on the emergency signal line 4R, the light-emitting element 35 can be lit in sync with the audio signal for the emergency public address. Additionally, by identifying the emergency alarm based on the volume of the audio signal on the emergency signal line 4R, the light-emitting element 35 can also be lit in sync with the emergency alarm.

### (4) First Example of Another Configuration

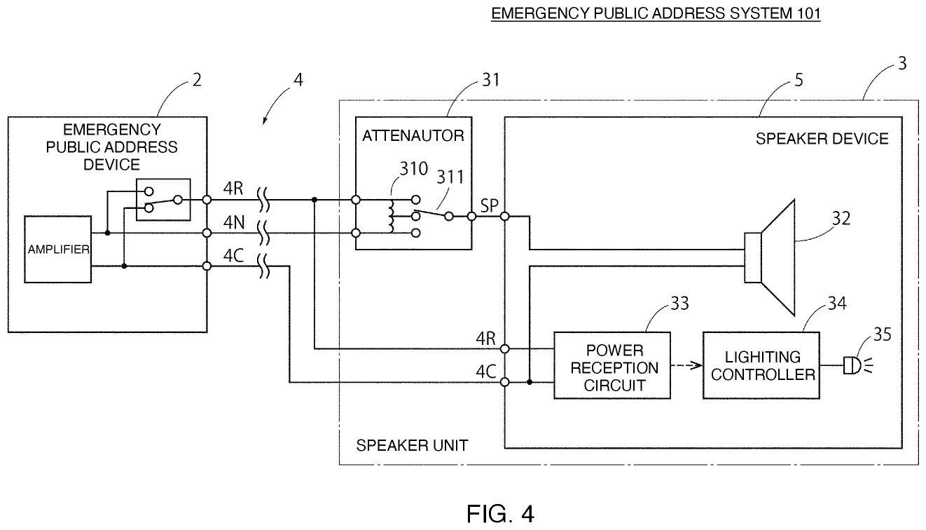

FIG. 4 is a diagram showing the first example of another configuration of the emergency public address system according to the first embodiment of the present invention, illustrating the emergency public address system 101. The emergency public address system 101 differs from the emergency public address system 100 (FIG. 2) in that the speaker unit 3 includes an attenuator 31 and a speaker device 5, with the speaker device 5 connected to the speaker line 4 via the attenuator 31.

The speaker device 5 includes a speaker 32, a power reception circuit 33, a lighting controller 34, and a light-emitting element 35. By connecting the attenuator 31, the configuration becomes identical to that of the speaker unit 3 in the emergency public address system 100 (FIG. 2). The speaker device 5 and the attenuator 31 are positioned in close proximity to each other. For example, the speaker device 5 and the attenuator 31 may be installed in the same indoor space, with the speaker device 5 mounted on the ceiling and the attenuator 31 on the wall.

In other words, the speaker unit 3 may have all its components 31 to 35 housed within the same casing and integrally configured. However, as long as they are placed in close proximity and connected to each other, any of the components may also be separable.

### (5) Second Example of Another Configuration

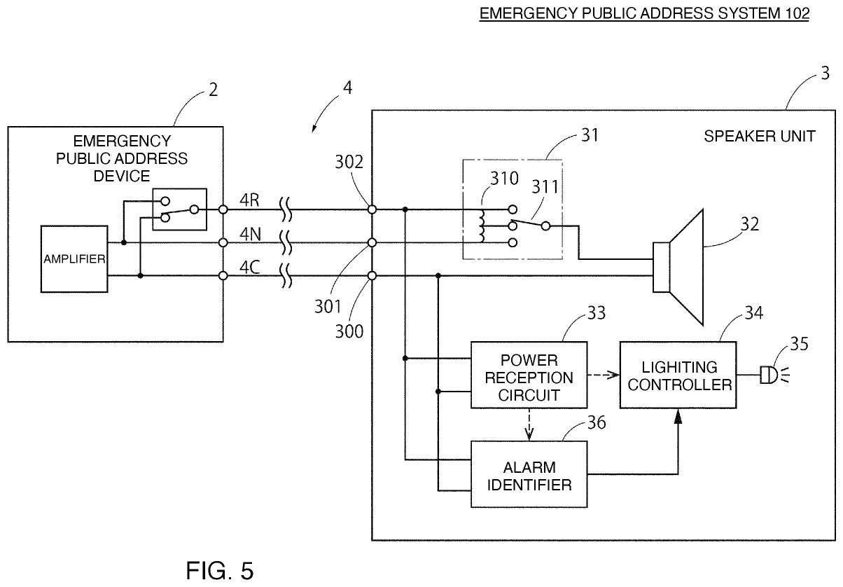

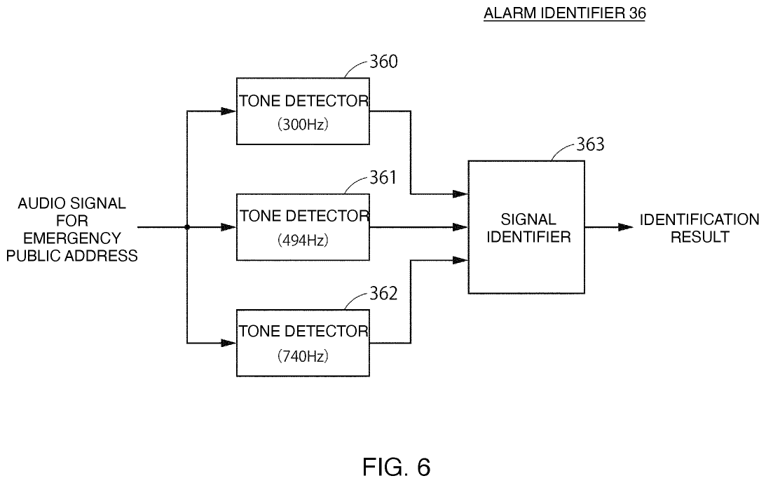

FIG. 5 and FIG. 6 are diagrams showing the second example of another configuration of the emergency public address system according to the first embodiment of the present invention. FIG. 5 illustrates the emergency public address system 102, and FIG. 6 shows the detailed configuration of the alarm identifier 36 in FIG. 5. The speaker unit 3 in the emergency public address system 102 differs from the speaker unit 3 in the emergency public address system 100 (FIG. 2) in that it includes an alarm identifier 36.

The alarm identifier 36 is a unit configured to identify the emergency alarm based on the frequency components contained in the audio signal and operates using the power supplied from the power reception circuit 33. The alarm identifier 36 is connected to the emergency signal line 4R and receives the audio signal for the emergency public address. By detecting whether the audio signal contains the predetermined frequency components of the emergency alarm, it can identify whether the audio signal is an emergency alarm. The alarm identifier 36 includes one or more tone detectors 360 to 362 and a

signal identifier 363. The tone detectors 360 to 362 are circuits configured to detect (tone detection) whether the audio signal contains predetermined frequency components that differ from each other. The signal identifier 363 identifies whether the input audio signal is an emergency alarm based on the detection results from the tone detectors 360 to 362. The result of the emergency alarm identification is output to the lighting controller 34.

Generally, an emergency alarm is composed of a frequency signal consisting of a single frequency component. For example, tone alarm sounds that sequentially output two or more different frequency signals for a certain period, or sweep alarm sounds that output a frequency signal while sweeping the frequency from a first frequency to a second frequency, are commonly used. Therefore, if the presence of a frequency specific to the emergency alarm is identified in the audio signal, the emergency alarm can be detected.

For example, in the case of a tone alarm that alternately outputs 740 Hz and 494 Hz for 0.5 seconds each, the emergency alarm can be detected with high accuracy by detecting the frequency components of 740 Hz and 494 Hz, respectively. It is also possible to detect only one of the frequencies and consider the emergency alarm detected throughout the repetition cycle.

In the case of a sweep signal that sweeps the frequency from 300 Hz to 2 kHz over 0.5 seconds, the emergency alarm can be detected with high accuracy and false detections can be prevented by detecting the frequency components of 300 Hz and 2 kHz, respectively. It is also possible to detect only the frequency component at the start of the sweep (300 Hz) and consider the emergency alarm detected throughout the sweep duration.

The lighting controller 34 drives the light-emitting element 35 based on the identification result of the emergency alarm. Therefore, the light-emitting element 35 can be lit in sync with the emergency alarm.

By identifying the emergency alarm through tone detection, it is possible to identify the emergency alarm with higher accuracy compared to using volume-based identification. Additionally, by performing tone detection on the audio signal of the emergency public address, the occurrence of false detections can be reduced compared to when tone detection is performed on the audio signal of the regular public address, which may also include BGM and other content.

### Second Embodiment

In the first embodiment, examples of the emergency public address systems 100 to 102 using a three-wire speaker line 4 were described. In this embodiment, the emergency public address systems 103 and 104 using a four-wire speaker line 4 will be explained.

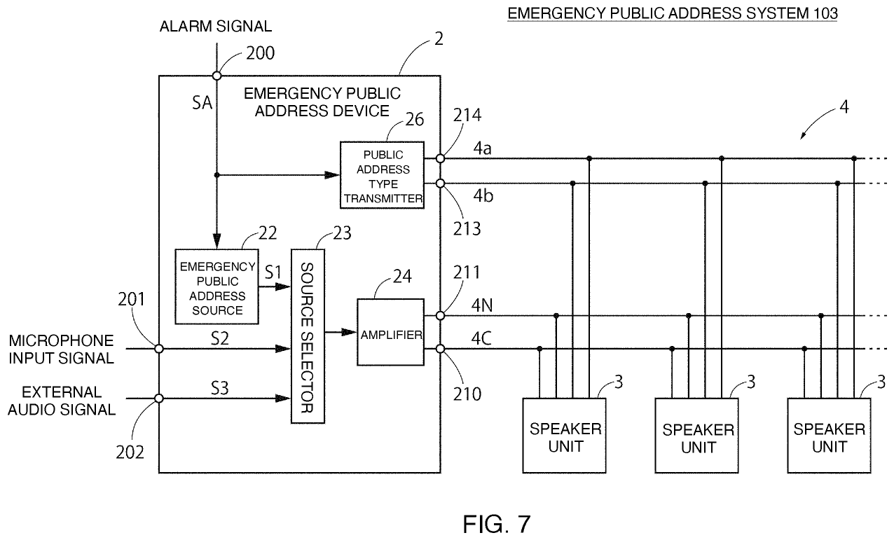

FIG. 7 is a diagram showing an example of the configuration of the emergency public address system according to the second embodiment of the present invention, illustrating the emergency public address system 103. In the emergency public address system 103, one or more speaker units 3 are connected to the emergency public address device 2 via a four-wire speaker line 4.

The speaker line 4 includes a common line 4C, a normal signal line 4N, and a pair of type signal lines 4a and 4b. Compared to the speaker line 4 of the emergency public address system 100 (First Embodiment), it differs in that it has a pair of type signal lines 4a and 4b instead of the emergency signal line 4R. The pair of type signal lines 4a and 4b transmit a public address type signal that indicates the operational status of the emergency public address device 2. The public address type signal indicates whether the current public address status is a regular public address or an emergency public address.

The emergency public address device 2 includes input terminals 200 to 202, output terminals 210, 211, 213, 214, an emergency public address source 22, a source selector 23, an amplifier 24, and a public address type transmitter 26. Compared to the emergency public address system 100 (First Embodiment), it differs in that it has a public address type transmitter 26 instead of the emergency public address relay 25. The amplified signal from the amplifier 24 is output to the normal signal line 4N via the output terminal 211. The public address type transmitter 26 outputs a public address type signal to the type signal lines 4a and 4b based on the alarm signal SA. For example, it transmits the public address type signal by associating regular and the emergency public address with voltage levels of 24V and 0V, respectively, and controlling the voltage between the pair of type signal lines 4a and 4b to 24V or 0V.

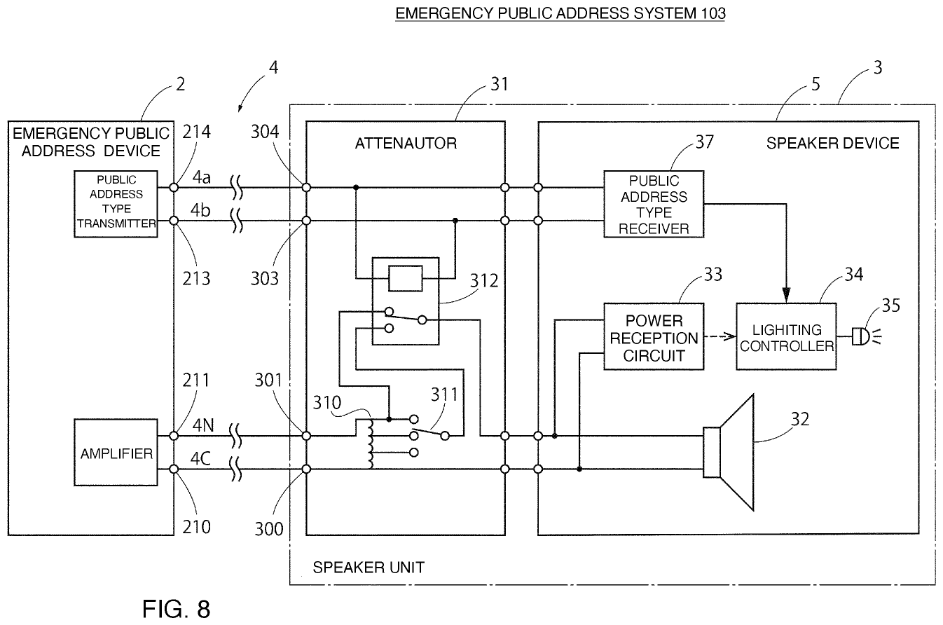

FIG. 8 is a diagram showing an example of the detailed configuration of the speaker unit 3 in FIG. 7. The speaker unit 3 includes an attenuator 31 and a speaker device 5. The attenuator 31 includes an autotransformer 310, a volume control switch 311, and a disabling relay 312.

The input terminal pair provided at both ends of the coil of the autotransformer 310 is connected to the normal signal line 4N and the common line 4C. One end of the coil is connected to the speaker 32, and one or more output taps are provided on the coil. These output taps are all connected to the volume control switch 311. The volume control switch 311 allows the user to select one of the two or more output taps, and the selected output tap is connected to the speaker 32 via the disabling relay 312.

The disabling relay 312 is a switch that operates based on the public address type signal to disable volume adjustment during the emergency public address. If the public address type signal indicates a regular public address, the disabling relay 312 inputs the output of the volume control switch 311 to the speaker 32, allowing the audio signal to be attenuated according to user operation. However, if the public address type signal indicates an emergency public address, the disabling relay 312 connects the other end of the secondary coil directly to the speaker 32, inputting the audio signal to the speaker 32 without attenuation.

The public address type receiver 37 is a unit configured to receive the public address type signal from the type signal lines 4a and 4b and identify whether the public address is an emergency public address. If it is an emergency public address, the public address type receiver 37 outputs a lighting control signal to the lighting controller 34 to light the light-emitting element 35.

The power reception circuit 33 is a circuit that extracts power from the audio signal. It is connected to the output terminal of the audio signal from the attenuator 31, rectifies the audio signal input to the speaker 32 to generate a DC voltage, and supplies it to the lighting controller 34. Since the attenuator 31 disables the volume control switch 311 during an emergency public address, the power reception circuit 33 can generate power from the audio signal that has not been attenuated during the emergency public address. Additionally, the power reception circuit 33 can also be connected to the normal signal line 4N upstream of the autotransformer 310.

The lighting controller 34 lights the light-emitting element 35 during an emergency public address based on the identification result from the public address type receiver 37. The lighting controller 34 is a constant current circuit that supplies a constant current to the light-emitting element 35, ensuring that the light-emitting element 35 is lit with consistent brightness. Additionally, the lighting controller 34 supplies power to the light-emitting element 35 when the output voltage of the power reception circuit 33 exceeds a predetermined threshold voltage Vth. As a result, the lighting of the light-emitting element 35 is based on both the public address type identification and the signal level of the audio signal.

For example, the lighting controller 34 can be configured to supply power to the light-emitting element 35 when the output voltage of the power reception circuit 33 exceeds a relatively low threshold voltage Vth. In this case, power is supplied to the light-emitting element 35 not only when the audio signal is an emergency alarm but also when it is content with a lower volume, such as evacuation guidance messages. Therefore, the light-emitting element 35 can be lit in sync with the audio signal of the emergency public address.

Alternatively, the lighting controller 34 can be configured to supply power to the light-emitting element 35 only when the output voltage of the power reception circuit 33 exceeds a relatively high threshold voltage Vth. In this case, power is supplied to the light-emitting element 35 only when the audio signal is an emergency alarm. Therefore, the light-emitting element 35 can be lit in sync with the emergency alarm.

In this embodiment, power is extracted from the audio signal to light the light-emitting element 35, allowing it to be lit without the need for an additional external power source. Additionally, by identifying whether it is an emergency public address based on the public address type signal received via the type signal lines 4a and 4b, the light-emitting element 35 can be lit during an emergency public address. Furthermore, by supplying a constant current to the light-emitting element 35, it can be lit with consistent brightness.

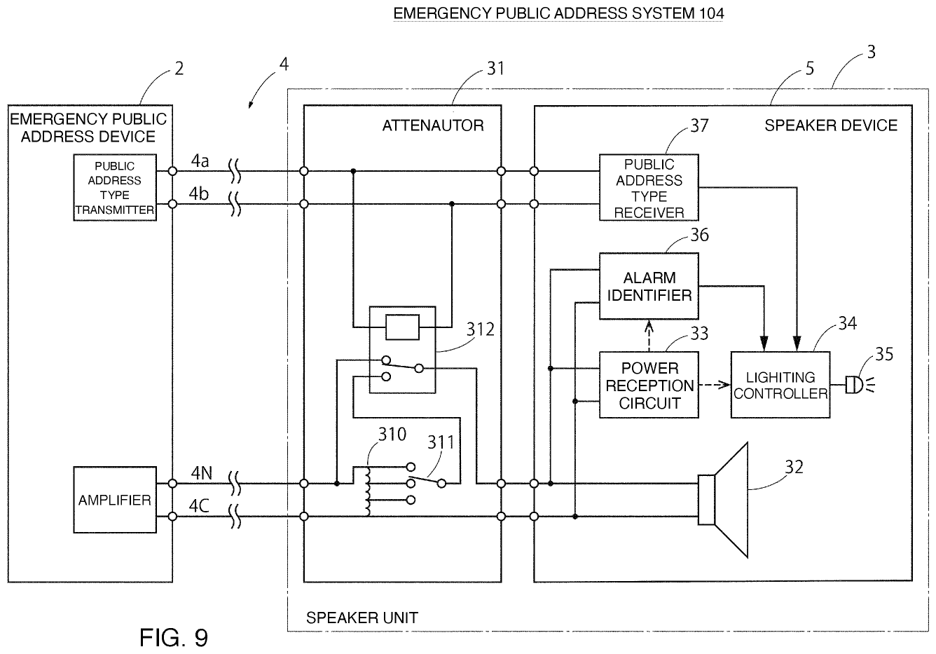

FIG. 9 is a diagram showing another configuration example of the emergency public address system according to the second embodiment of the present invention, illustrating the emergency public address system 104. The emergency public address system 104 differs from the emergency public address system 103 (FIG. 8) in that the speaker unit 3 further includes an alarm identifier 36.

The alarm identifier 36 is a unit configured to identify the emergency alarm through tone detection and operates using the power supplied from the power reception circuit 33. The internal configuration of the alarm identifier 36 is the same as in the emergency public address system 102 (FIG. 5). The alarm identifier 36 is connected to the output terminal of the audio signal from the attenuator 31 and receives the audio signal input to the speaker 32. By detecting whether the audio signal contains the predetermined frequency components of the emergency alarm, it can identify whether the audio signal is an emergency alarm.

The lighting controller 34 lights the light-emitting element 35 in sync with the emergency alarm based on the identification results from both the public address type receiver 37 and the alarm identifier 36. In other words, the light-emitting element 35 is lit when it is identified as an emergency public address based on the public address type signal and also identified as an emergency alarm through tone detection. This allows the emergency alarm to be identified with high accuracy and the light-emitting element 35 to be lit in sync with the emergency alarm. Additionally, the lighting controller 34 is a constant current circuit that supplies a constant current to the light-emitting element 35, ensuring it lights with consistent brightness during the output of the emergency alarm.

### Third Embodiment

In the first and second embodiments, examples of the emergency public address systems 100 to 104 using three-wire or four-wire speaker lines 4 were described. In contrast, this embodiment explains the emergency public address system 105 using a two-wire speaker line 4.

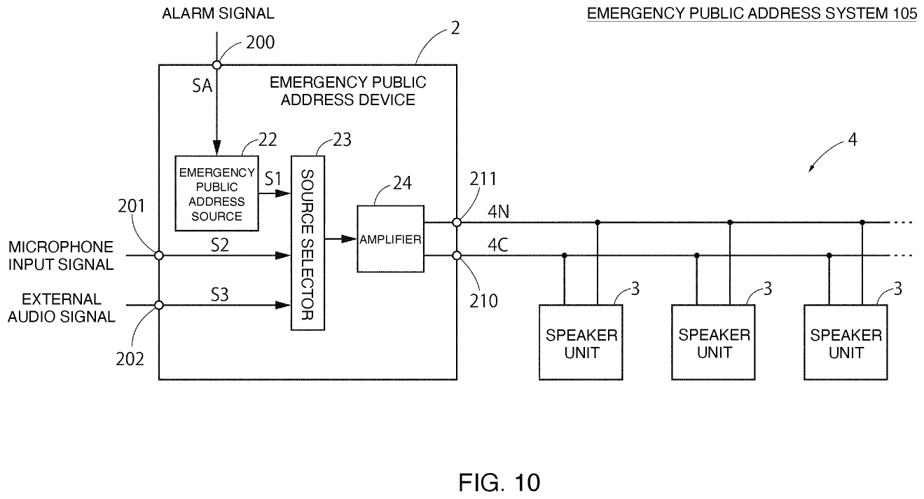

FIG. 10 is a diagram showing an example of the configuration of the emergency public address system according to the third embodiment of the present invention, illustrating the emergency public address system 105. In the emergency public address system 105, one or more speaker units 3 are connected to the emergency public address device 2 via a two-wire speaker line 4.

The speaker line 4 includes a common line 4C and a normal signal line 4N. Compared to the speaker line 4 of the emergency public address system 100 (FIG. 1), it differs in that it does not include an emergency signal line 4R.

The emergency public address device 2 switches between the regular public address and the emergency public address based on the alarm signal SA, selectively generating either the audio signal for the regular public address or the audio signal for the emergency public address. However, it does not include an emergency public address relay 25, and both the emergency public address and the audio signal for the emergency public address are transmitted to each speaker unit 3 via the normal signal line 4N.

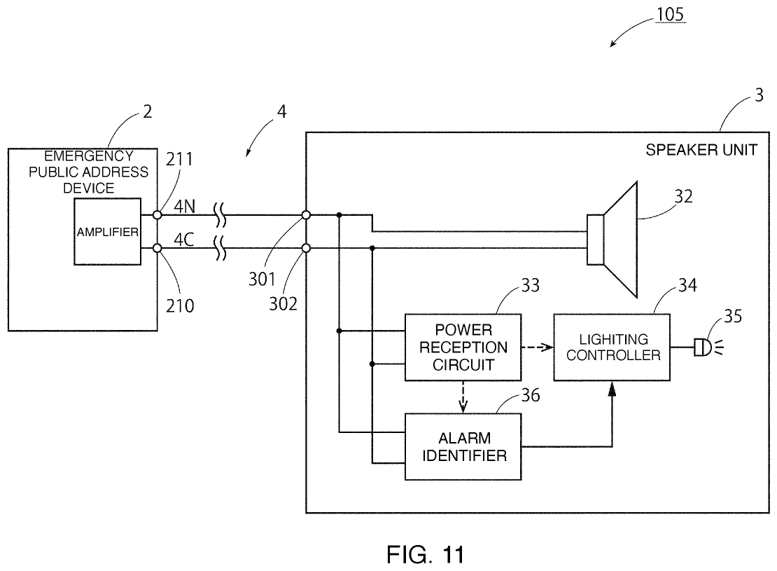

FIG. 11 is a diagram showing an example of the detailed configuration of the speaker unit 3 in FIG. 10. The speaker unit 3 does not include an attenuator 31, so the audio signal received via the normal signal line 4N is directly input to the speaker 32. In other words, the audio signals for both the regular public address and the emergency public address are input to the speaker 32 without distinction.

The power reception circuit 33 is a circuit that extracts power from the audio signal. It is connected to the normal signal line 4N, rectifies the audio signal to generate a DC voltage, and supplies it to the lighting controller 34 and the alarm identifier 36.

The alarm identifier 36 is a unit configured to identify the emergency alarm through tone detection and operates using the power supplied from the power reception circuit 33. The alarm identifier 36 is connected to the normal signal line 4N and identifies whether the audio signal is an emergency alarm by detecting whether the audio signal contains the predetermined frequency components of the emergency alarm. The identification result from the alarm identifier 36 is output to the lighting controller 34.

The lighting controller 34 drives the light-emitting element 35 based on the identification result of the emergency alarm. Therefore, the light-emitting element 35 can be lit in sync with the emergency alarm.

### Fourth Embodiment

In this embodiment, other configuration examples of the power reception circuit 33 in FIG. 2 will be explained. Specifically, the configurations of the power reception circuit 33, which suppress the distortion of public address audio caused by the nonlinearity of the power reception circuit 33 and the lighting controller 34, will be described.

Due to the nonlinearity of load circuits such as the power reception circuit 33 and the lighting controller 34, the current changes flowing from the speaker line 4 to the speaker unit 3 become nonlinear with respect to voltage changes. Since the speaker line 4 has line resistance, such nonlinear current changes cause nonlinear voltage drops, resulting in distortion voltage appearing on the speaker line 4. This issue is particularly problematic if the line resistance of the speaker line 4 is large, as the distortion voltage increases, leading to distortion of the audio signal input to the speaker unit 3, which negatively impacts the clarity of the audio.

Generally, an emergency public address system is configured by connecting numerous speaker units 3 to the speaker line 4. Therefore, the speaker line 4 is laid over long distances, for example, 500 meters to 1000 meters, and its line resistance is expected to reach relatively high values, such as several tens of ohms.

Distortion voltage specifically manifests as harmonics relative to the fundamental frequency of the audio signal, occurring either steadily or transiently. When the line resistance of the speaker line 4 is large, these harmonics also become more pronounced. Generally, for audio signals, distortion relative to the fundamental frequency—such as when the total value of all harmonics and other noise exceeds 1%—can be audibly recognized and is considered unpleasant to the ear.

Therefore, by providing a current suppression circuit between the speaker line 4 and the bridge circuit BR, the generation of distortion voltage can be suppressed. The current suppression circuit reduces the intake of current from the speaker line 4, suppresses the current flowing when the capacitor C1 is charged, and softens the switching transitions of the nonlinear parts of the rectifier circuit BR. This helps in suppressing current distortion.

The current suppression circuit can be configured of passive elements such as inductors, resistors, or a combination of these. Additionally, the current suppression circuit may be designed so that the current increases proportionally with the input voltage up to a certain level, but beyond that voltage, the current decreases proportionally, reaching a minimum current (e.g., 0 A) before the rated voltage is reached. Alternatively, the current suppression circuit could be designed so that it acts as a constant resistive load up to a certain input voltage, with the load resistance increasing proportionally with higher voltages. Another possible design is that the circuit acts as a constant resistive load up to a certain voltage but becomes a constant current circuit beyond that voltage.

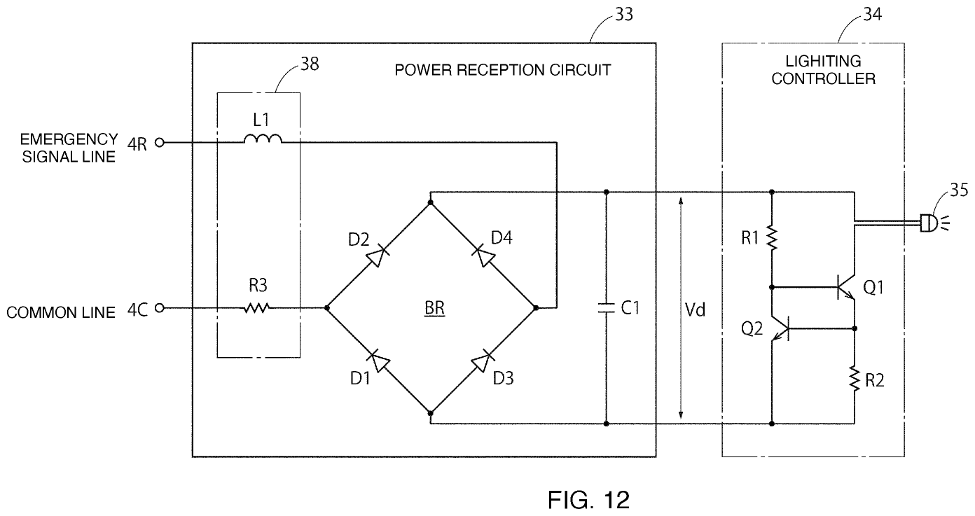

FIG. 12 is a diagram showing an example of the configuration of the power reception circuit 33 according to the fourth embodiment of the present invention, illustrating another configuration example of the power reception circuit 33 in FIG. 2. This power reception circuit 33 differs from the power reception circuit 33 in FIG. 3 (First Embodiment) in that it includes a current suppression circuit 38.

The current suppression circuit 38 includes an inductor L1 and a resistor R3. The inductor L1 is provided on one of the input terminals of the bridge circuit BR, and the resistor R3 is provided on the other. In the diagram, the inductor L1 is shown as being connected to the input terminal connected to the emergency signal line 4R, and the resistor R3 is connected to the input terminal connected to the common line 4C. However, the configuration can also be reversed, with the inductor L1 and resistor R3 swapped.

The inductor L1 has the property of becoming less conductive to current as the frequency increases. Therefore, the current suppression circuit 38 functions as a filter circuit that suppresses harmonic currents flowing from the speaker line 4, thereby reducing the generation of distortion voltage.

The greater the degree to which the current suppression circuit 38 suppresses current, the more effectively harmonic generation is reduced. However, this also increases the time required for the capacitor C1 to accumulate charge, which can worsen the response time for lighting the light-emitting element 35. It is desirable to adjust the current suppression circuit 38, considering both the response time and the clarity of the audio, so that the harmonic distortion remains within an audibly acceptable range, such as keeping the voltage of the distortion components below 1% of the fundamental frequency.

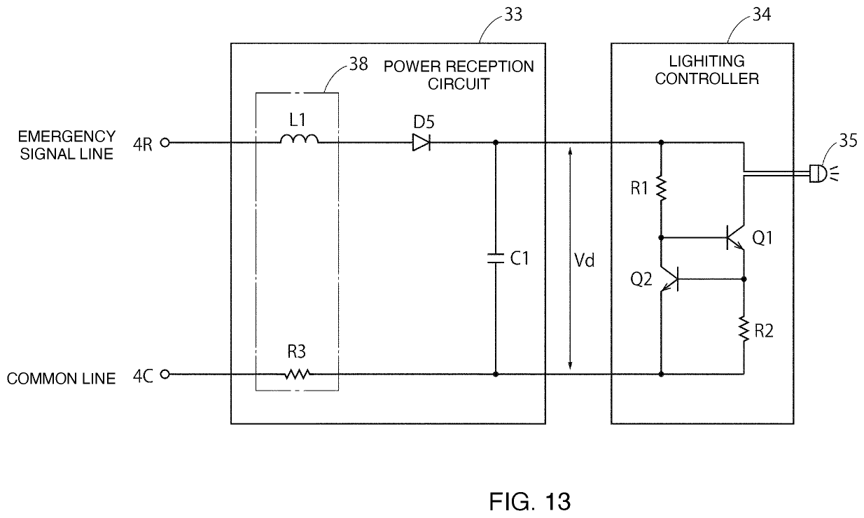

FIG. 13 is a diagram showing another configuration example of the power reception circuit 33 according to the fourth embodiment of the present invention, illustrating another configuration example of the power reception circuit 33 in FIG. 2 (First Embodiment). This power reception circuit 33 differs from the power reception circuit 33 in FIG. 12 in that it includes a single diode D5 instead of the bridge circuit BR, performing half-wave rectification together with the capacitor C1. This configuration allows for the extraction of DC power with a simpler circuit design.

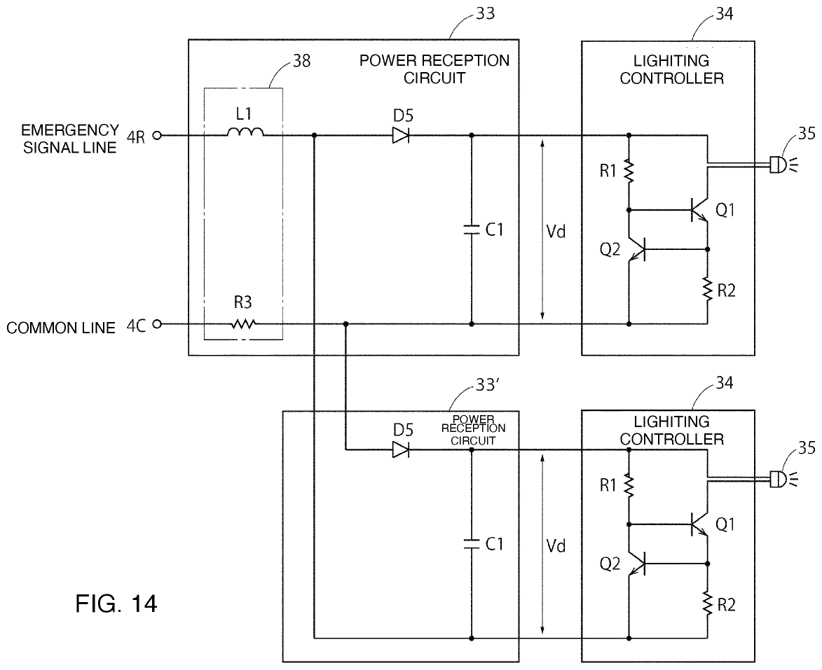

When the power reception circuit 33 is configured for half-wave rectification, as shown in FIG. 14, it is desirable for a pair of power reception circuits 33 and 33′, each connected to separate lighting controllers 34, to share a single current suppression circuit 38 and be connected in such a way that they operate in opposite phases. This pair of power reception circuits 33 and 33′ can be housed within the same speaker unit 3, or they can be placed in separate speaker units 3. In the latter case, the two speaker units 3 form a pair of speaker units.

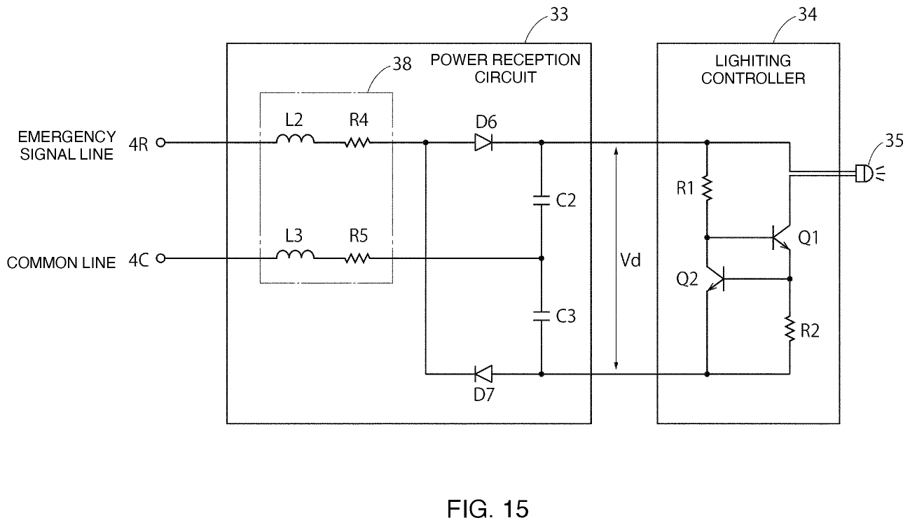

FIG. 15 is a diagram showing yet another configuration example of the power reception circuit 33 according to the fourth embodiment of the present invention, illustrating another configuration example of the power reception circuit 33 in FIG. 2 (First Embodiment). This power reception circuit 33 differs from the power reception circuit 33 in FIG. 12 in that it includes two diodes D6 and D7 and two capacitors C2 and C3 instead of the bridge circuit BR and the capacitor C1.

The diode D6 and capacitor C2 perform half-wave rectification when the AC voltage of the audio signal is positive, while the diode D7 and capacitor C3 perform half-wave rectification when the AC voltage of the audio signal is negative. In other words, diodes D6 and D7, along with capacitors C2 and C3, form a voltage-doubling rectifier circuit. This configuration can also be used to extract DC power.

The current suppression circuit 38 includes a series circuit of an inductor L2 and a resistor R4 provided on one of the input terminals of the power reception circuit 33, and a series circuit of an inductor L3 and a resistor R5 provided on the other input terminal.

Additionally, by placing a transformer between the speaker line 4 and the power reception circuit 33 to provide isolation, it is possible to prevent electric shock if a person touches the light-emitting element 35 or other components. Although it is generally not expected that a person would directly touch the speaker wiring or the speaker's voice coil, the light-emitting element 35 and similar components are considered more likely to be touched.

### REFERENCE SIGNS LIST

100-105 Emergency public address system
2 Emergency public address device
200-202 Input terminals
210-213 Output terminals
22 Emergency public address source
23 Source selector
24 Amplifier
25 Emergency public address relay
26 Public address type transmitter
3 Speaker unit
300-302 Input terminals
31 Attenuator
310 Autotransformer
311 Volume control switch
312 Disabling relay
32 Speaker
33 Power reception circuit
34 Lighting controller
35 Light-emitting element
36 Alarm identifier
360-362 Tone detectors
363 Signal identifier
37 Public address type receiver
38 Current suppression circuit
4 Speaker line
4C Common line
4N Normal signal line
4R Emergency signal line
4a, 4b Type signal lines
5 Speaker device
SA Alarm signal
S1 Audio signal
S2 Microphone input signal
S3 External audio source signal
BR Bridge circuit
C1-C3 Capacitors
D1-D7 Diodes
L1-L3 Inductors
Q1, Q2 Transistors
R1-R5 Resistors
Vd DC voltage

1. An emergency public address system, comprising:
an emergency public address device that switches between an arbitrary regular public address and an emergency public address, both public addresses including an audio signal, the emergency public address including an emergency alarm; and
one or more speaker units interrelated with the emergency public address device via a speaker line, wherein the speaker unit includes:
a speaker that receives the audio signal of the regular public address and the audio signal of the emergency public address,
a power reception circuit that extracts DC power from the audio signal of the emergency public address, and
a lighting controller that controls a lighting of a light-emitting element using the DC power, and
the light-emitting element does not light during the regular public address and lights during the emergency public address.

2. The emergency public address system according to claim 1, wherein
the speaker line includes a common line that transmits a reference level, a normal signal line that transmits the audio signal of the regular public address, and an emergency signal line that transmits the reference level during the regular public address and transmits the audio signal only during the emergency public address,
the speaker receives the audio signal from the normal signal line during the regular public address and receives the audio signal from the emergency signal line during the emergency public address, and
the power reception circuit extracts the DC power from the audio signal only on the emergency signal line.

3. The emergency public address system according to claim 1, wherein
the lighting controller identifies whether the emergency public address device is performing the emergency public address based on a signal level of the speaker line, and
the light-emitting element lights in sync with the emergency public address based on an identification result.

4. The emergency public address system according to claim 1, wherein
the lighting controller identifies whether the emergency alarm is being output from the emergency public address device based on a signal level of the speaker line, and
the light-emitting element lights in sync with the emergency alarm based on an identification result.

5. The emergency public address system according to claim 1, further comprising:
an alarm identifier that identifies whether the emergency alarm is being output from the emergency public address device based on a frequency component contained in the audio signal on the speaker line, wherein
the light-emitting element lights in sync with the emergency alarm based on an identification result.

6. The emergency public address system according to claim 1, further comprising:
a public address type receiver that receives a public address type signal, from the emergency public address device, indicating either the regular public address or the emergency public address, wherein
the speaker line includes a pair of audio signal lines that transmit the audio signal and a pair of type signal lines that transmit the public address type signal, and
the power reception circuit generates the DC power from the audio signal on the audio signal lines.

7. The emergency public address system according to claim 6, wherein
the lighting controller identifies whether the audio signal is being output from the emergency public address device based on a signal level of the audio signal, and
the light-emitting element lights in sync with the audio signal of the emergency public address.

8. The emergency public address system according to claim 6, wherein
the lighting controller identifies whether the emergency alarm is being output from the emergency public address device based on a signal level of the audio signal, and
the light-emitting element lights in sync with the emergency alarm.

9. The emergency public address system according to claim 6, further comprising:
an alarm identifier that identifies whether the emergency alarm is being output from the emergency public address device based on a frequency component contained in the audio signal, wherein
the light-emitting element lights in sync with the emergency alarm based on the public address type signal and an identification result.

10. A speaker unit connected via a speaker line to an emergency public address device that switches between an arbitrary regular public address and an emergency public address, both public addresses including an audio signal, the emergency public address including an emergency alarm, and to which the audio signals are transmitted from the emergency public address device, the speaker unit comprising:
a speaker that receives the audio signal of the regular public address and the audio signal of the emergency public address;
a power reception circuit that extracts DC power from the audio signal of the emergency public address; and
a lighting controller that controls a lighting of a light-emitting element using the DC power, wherein
the light-emitting element does not light during the regular public address and lights during the emergency public address.

11. The speaker unit according to claim 10, wherein the power reception circuit includes:
a rectifier circuit that rectifies the audio signal,
a capacitance that smooths an output voltage of the rectifier circuit, and
a current suppression circuit that suppresses a generation of harmonics of the audio signal in the speaker line.

12. A public address system, comprising:
a public address device that selectively operates in an emergency mode or a non-emergency mode, wherein a regular public address is performed in the non-emergency mode and an emergency public address is performed in the emergency mode, wherein the emergency public address includes an output of an emergency alarm;
one or more speakers connected to the public address device via a speaker line, each speaker being receiving an audio signal of the regular public address and an audio signal of the emergency public address;
a light-emitting element;
a power reception unit that extracts DC power from the audio signal on the speaker line to supply the DC power to the light-emitting element for activating the light-emitting element; and
a controller that enables DC power extraction by the power reception unit based on the audio signal of the emergency public address only in the emergency mode and disables the DC power extraction in the non-emergency mode.

13. The public address system according to claim 12, wherein the controller includes one or more tone detectors connected to the speaker line, the one or more tone detectors detecting predetermined frequency components contained within the emergency alarm and enabling the DC power extraction only when detecting the predetermined frequency components.

14. The public address system according to claim 12, further comprising an attenuator including a transformer to provide volume control of the audio signal on the speaker line between the public address device and each speaker,
wherein the attenuator attenuates the volume of the audio signal of the regular public address based on a user selection of one of output taps in the transformer, and does not attenuate the volume of the audio signal of the emergency public address regardless of the user selection of the output taps, and the controller supplies power from the power reception unit to the light-emitting element only when an output of the power reception unit is not below a threshold voltage corresponding to the volume of the audio signal of the emergency public address.

15. The public address system according to claim 12, wherein the emergency public address includes an output of a guidance message with the emergency alarm, the emergency alarm is louder than the guidance message, and the controller supplies power from the power reception unit to the light-emitting element only when an output of the power reception unit is not below a threshold voltage corresponding to the volume of the audio signal of the emergency alarm.

16. The public address system according to claim 12, wherein the speaker line includes (a) a normal signal line that carries the audio signal of the regular public address in the non-emergency mode and the audio signal of the emergency public address in the emergency mode and (b) an emergency signal line that carries the audio signal of the emergency public address only in the emergency mode while maintaining a reference level during the non-emergency public address mode, wherein the power reception unit is connected to the line and is not connected to the normal signal line so as to rectify the audio signal only on the line.

17. The public address system according to claim 12, wherein the controller includes a public address type receiver that receives a public address type signal indicating either the regular public address or the emergency public address, so as to supply power from the power reception unit to the light-emitting element only when the public address type signal indicating the emergency public address is received by the public address type receiver.
